(19) United States
(12) Patent Application Publication
(10) Pub. No.: US 2004/0229569 A1
(43) Pub. Date: Nov. 18, 2004

(54) Door answering systems and methods

(75) Inventor: Matthias Franz, Altdorf (DE)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/436,068

(22) Filed: May 13, 2003

(51) Int. Cl. H04M 1/68; H04M 3/16

(52) U.S. Cl. 455/66.1; 455/411; 455/412.1; 455/41.2; 340/5.8; 379/167.05

(57) ABSTRACT

An automatic door answering system is provided which automatically leaves a resident's message for a visitor. The system includes a wireless communication interface arranged to directly communicate with a visitor's wireless communication system and to receive authentication information from the visitor's wireless communication system. The system further includes a message output component. It is arranged to check the identity of the visitor based on the authentication information received and, in response to the result of the identity check, to cause the message output component to output a resident's message.

### FIELD OF THE INVENTION

The present invention relates generally to door answering systems and methods, and, for example, to automatic door answering systems and methods for automatically leaving a resident's message to a visitor.

### BACKGROUND OF THE INVENTION

With people becoming mobile, more homes are left unattended during working hours. Visitors, like friends, neighbors, mailmen or delivery men, often find no one answering doors. When absent from his home or place of business the resident might wish to leave a message to a particular visitor he expects to come around. Nowadays, sometimes written messages are attached to the door that everybody else could read. The same situation occurs for the visitor who wants to leave a message to the absent resident. If he attaches a written message to the door, every other visitor will be able to read this message.

DE 298 20 860 U1 discloses an automatic door answering system which enables the visitor to receive a resident's message when he enters a visitor's code at a key pad installed near the door. Upon identification of the visitor the resident's message is played to him via a loudspeaker. The visitor may further leave a voice message to the resident by speaking into a microphone. The voice message thus recorded is transmitted via a modem to the visitor's pager or mobile phone.

U.S. Pat. No. 6,233,328 B1 discloses a door intercom system which is coupled to a resident's telecommunication system. A visitor might record a message for the resident on a common recording system coupled to the telecommunication system by speaking into a microphone of the door intercom system. This recording system may also be used to replay resident's messages to the visitor, to thereby request information from the visitor, such as the person he wishes to speak with. The information will then be used to determine how to establish a telephone connection with this person via the telecommunication system.

U.S. Pat. No. 5,657,380 discloses an automatic door answering system comprising two units which communicate with each other via an RF link. One unit is fixedly installed at the door, the other unit is left in the resident's home. The automatic door answering system plays messages to and records messages from visitors. It uses voice recognition and synthesis to interact with visitors.

U.S. Pat. No. 6,161,005 discloses a remote door locking/unlocking system which includes a wireless radio frequency sensor for enabling the system to be actuated by any mobile phone. Upon identification of the visitor via the wireless communication link established between the visitor's mobile phone and the wireless radio frequency sensor, the door will be unlocked. The identification might require entry of a password.

GB 2 342 005 A discloses an automatic door answering system which comprises a cordless phone (such as that employing the DECT cordless phone standard) fixedly installed at the door as a door-entry phone. A visitor might manually input a code into this door-entry phone in order to unlock the door. Furthermore, the automatic door answering system might replay an interrogating message to the visitor calling at the door and might record messages left by the visitor.

### SUMMARY OF THE INVENTION

A first aspect of the invention is directed to an automatic door answering system for automatically leaving a resident's message to a visitor. The system comprises a wireless communication interface arranged to directly communicate with the visitor's wireless communication system and to receive authentication information from the visitor's wireless communication system. The system further comprises a message output component. The system is arranged to check the identity of the visitor based on the authentication information and, in response to the result of the identity check, to cause the message output component to output a resident's message.

According to a further aspect, the invention is directed to an automatic door answering system for automatically leaving a resident's message to a visitor. The system comprises a wireless communication interface arranged to directly communicate with a visitor's wireless communication system and to receive identification information from the visitor's wireless communication system. The system further comprises a message output component. It is arranged to cause the message output component to output a resident's message in response to the identification information received.

According to another aspect, the invention is directed to a method for automatically answering the door by using an automatic door answering system and a visitor's wireless communication system. The method comprises the steps of: establishing a direct wireless communication link between the visitor's wireless communication system and the automatic door answering system upon arrival of the visitor at the door; transmitting authentication information from the visitor's wireless communication system to the door answering system via the direct wireless communication link established; checking the identity of the visitor based on the authentication information transmitted; and outputting a resident's message to the visitor in response to the result of the identity check.

According to still another aspect, the invention is directed to a method for automatically answering the door by using an automatic door answering system and a visitor's wireless communication system. The method comprises the steps of: establishing a direct wireless communication link between the visitor's wireless communication system and the automatic door answering system upon arrival of the visitor at the door; transmitting identification information from the visitor's wireless communication system to the door answering system via the established direct wireless communication link; and outputting a resident's message to the visitor in response to the identification information transmitted.

According to still another aspect, the invention is directed to an user wireless communication device which is arranged to communicate with an automatic door answering system for automatically leaving a resident's message for the user. The communication between the user wireless communication device and the automatic door answering system comprises a direct communication between the user wireless communication device and a wireless communication interface included in the automatic door answering system for receiving authentication information from the user wireless communication device and for causing the automatic door answering system to check the identity of the user based on the authentication information received and, in response to the result of the identity check, to output a resident's message.

According to still another aspect, the invention is directed to an user wireless communication device for use with an automatic door answering system for automatically leaving a resident's message for the user. The automatic door answering system comprises a wireless communication interface arranged to directly communicate with the user wireless communication device and to receive authentication information from the user wireless communication device. It further comprises a message output component. It is arranged to check the identity of the user based on the authentication information and, in response to the result of the identity check, to cause the message output component to output a resident's message.

Other features are inherent in the systems and method disclosed or will become apparent to those skilled in the art from the following detailed description of embodiments and its accompanying drawings.

### DESCRIPTION OF THE DRAWINGS

Embodiments of the invention will now be described, by way of example, and with reference to the accompanying drawings, in which:

FIG. 1 shows an exemplary representation of an embodiment of an automatic door answering system;

FIG. 2 shows an exemplary representation of another embodiment of an automatic door answering system;

FIG. 3 is a flow diagram for illustrating the method steps of an automatic door answering method.

### DESCRIPTION OF THE PREFERRED EMBODIMENTS

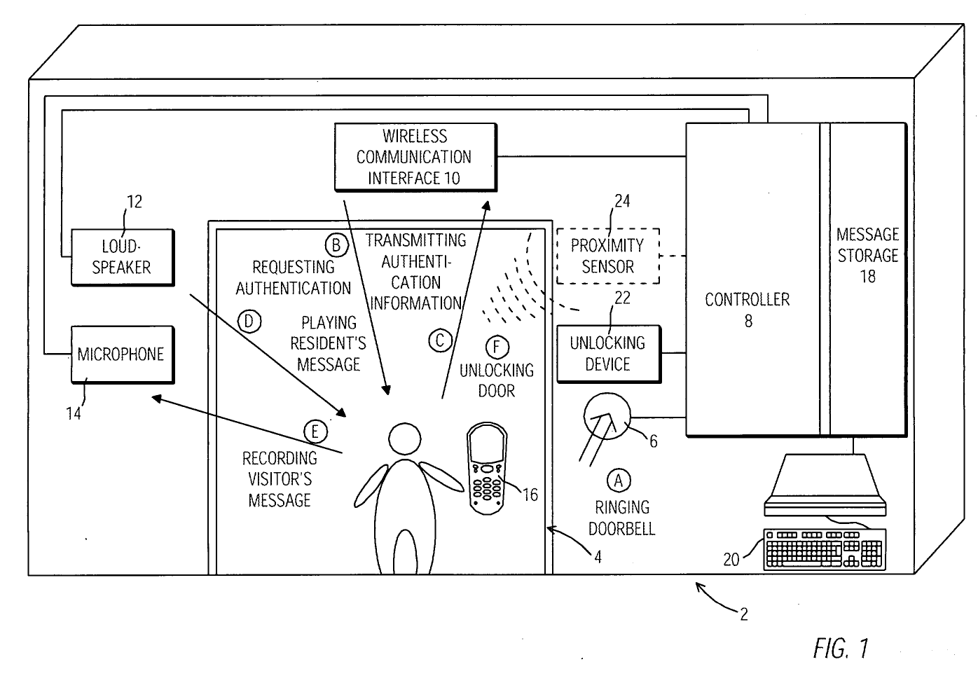

FIG. 1 shows an exemplary representation of an embodiment of an automatic door answering system and of a corresponding method. Before proceeding further with the description, however, a few items of the embodiments will be discussed.

The embodiments of the automatic door answering system which are described now in more detail are directed to an authentication of the visitor by means of a wireless communication system belonging to the visitor, i.e. carried by the visitor when arriving at the door, associated with the automatic door answering system. Such wireless communication systems comprise mobile phones, personal digital assistants (PDAs), notebooks, laptops, shirt pockets, palmtops, wristwatch computers, pagers and the like. It is to be understood that the aforementioned list of wireless communication systems is not exclusive and shall in particular comprise future wireless communication systems not yet available on the market.

An important aspect resides in establishing a direct communication link between the visitor's communication system and the wireless communication interface of the automatic door answering system, rather than an indirect link as used by most of the mobile phone communication standards. Such indirect links use intermediary base transceiver stations for relaying messages transmitted between two communication systems. For example, voice messages exchanged between two mobile phones are transmitted via those base transceiver stations over large distances even if these mobile phones which are communicating with each other are very close to one another. However, some of the modern mobile phones (as available to date, the filing date of the present application) additionally provide for at least one further wireless communication standard, used for example to transmit data such as phone numbers to other devices (laptops, etc.). Those direct wireless communication standards comprise non-exclusively Bluetooth, WLAN (Wireless Local Area Network), Airport, IrDA, Air, UWB (Ultra-Wideband), DECT, HomeRF, HiperLAN2, etc. It is to be appreciated that future wireless communication standards shall be included. Some of the explicitly listed wireless communication standards are based on IEEE 802.11, such as Bluetooth, WLAN and Airport. In general, the direct wireless communication mentioned may be based on radio frequency, infrared, visible light, and/or ultrasonic carrier signals.

Most of the above wireless communication standards make arrangements for the identification or authentication of the communications systems when involved in wireless communication with each other. Normally, all communication systems involved exchange their identity upon initiation of a wireless communication link. Mostly, the identity of each communication system is unique. Such a unique identification might be the device ID of the communication system. Some communication standards allow for the allocation of a temporary identity to each involved communication system which only serves to address a couple of communication systems when participating in a common direct communication. For example, according to the Bluetooth standard a common direct communication of up to eight communication systems might take place within a so-called piconet. In such a piconet, one of the communication systems plays the role of a master while the remaining ones function as slaves. Temporary identification numbers are used to differentiate between the communication systems participating in one piconet. If required, unique identification information is additionally transmitted or exchanged in order to find out the true identity of the communicating systems.

Hence, in many wireless communication standards the identity information exchanged between the communication systems actually connected is sufficient to identify the visitor. Sometimes, in particular when only temporarily allocated identities are used between the connected communication systems, a separate authentication procedure will become necessary in order to unambiguously identify the visitor. For this, the automatic door answering system causes the visitor's wireless communication system to transmit authentication information which allows the true identity of the visitor to be determined. This authentication information may be permanently stored within the visitor's wireless communication system, or it may be manually entered (in text message or voice message form, etc.) by the visitor into his wireless communication system when requested by the automatic door answering system. In some embodiments, the authentication procedure will also take place even if the connected communication systems have already exchanged unique device IDs or the like.

Generally, unique authentication information will be needed in order to unambiguously identify the visitor. In some cases, however, it might be sufficient to base the identification on some non-unique authentication information which, for example, merely identifies a group of visitors (even if each visitor uses his own communication system having a unique device ID), such as a group consisting of mailmen, delivery men and the like. For this, all visitors belonging to one of these groups may use wireless communication systems which all have the same authentication information stored in them.

In some embodiments of the automatic door answering system the resident's message is unchangeably stored. Such unchangeably stored messages may contain the information that the resident is currently not at home. The resident might then be merely able to enter various visitor's identities to whom he wishes to send this particular message during his absence. In other embodiments, the resident is able to input and store various different messages intended for different visitors he expects to arrive at his door during his absence. The automatic door answering system then selects the specific message upon identification of the visitor at the door.

As different visitors' communication systems enabling different communication standards may be required to cooperate with the same automatic door answering system, different wireless communication interfaces may be simultaneously provided for example. In this case, the message storage stores different kinds of authentication information for one visitor which consider all his different wireless communication systems when this visitor arrives at the resident's door. The kinds of authentication information might comprise, but are not limited to, unique device IDs, visitors' names, secret keys agreed between the visitor and the resident, and the like. The message storage stores one resident's message together with all the corresponding authentication information of the single visitor.

In some embodiments, the message storage is divided into different groups of visitors, such as family, friends, mailmen, etc. A resident's messages will then be simply allocated to each group, rather than to every individual person.

The stored resident's messages may comprise further information about the resident, such as a welcome website and the like.

In some embodiments, the resident's message is sent to the visitor's wireless communication system and/or played via a loudspeaker installed at the door. Naturally, other output devices may be alternatively or additionally provided for outputting the resident's message to the visitor, such as a video screen, a graphical or text display, a printer, etc. Accordingly, the resident's message will be presented in acoustical, optical, graphical or text form.

In some embodiments, the automatic door answering system is arranged to record in the message storage a visitor's message which is transmitted by a compatible input device. Hereby, the input device is the visitor's wireless communication system which enables the visitor to send text and/or voice messages or the like to the automatic door answering system and/or a separate input device fixedly installed at the door. Again, the direct communication link between the visitor's communication system and the automatic door answering system is used for transmitting such visitor's messages. In other embodiments, the visitor's message is transmitted via an indirect communication link based for example on a mobile phone communication standard, such as GSM (Global System for Mobile Communication), UMTS (Universal Mobile Telecommunications System) and the like. Similarly, the resident may be able to input his resident's messages via his wireless communication system (mobile phone, PDA, etc.) into the door answering system. In alternative embodiments, the visitor's and/or resident's input device for recording visitor's and/or resident's messages within the automatic door answering system is a microphone, alphanumeric key pad, or video camera, etc. It should be appreciated that the aforementioned list of input devices is not limited to the particular examples as given. Naturally, both the resident and the visitor may use input devices enabling the same communication standard for inputting their messages into the automatic door answering system. For instance, when both are using Bluetooth-enabled communication devices, the visitor's Bluetooth-enabled wireless communication system (mobile phone, etc.) will be used for recording and storing visitor's messages and the resident's wireless Bluetooth-enabled communication system (mobile phone, notebook, laptop, PDA, etc.) will be used to record and store resident's messages.

The resident's and/or visitor's messages may be digitally or analogously stored within the message storage. Converters may be provided for converting on the one hand messages inputted by the resident and on the other hand outputted to the visitor. The same holds for visitor's messages. These converters may differ from each other depending on the input form, the output form and the internally used form for storing messages. For instance, when using the visitor's wireless communication system for outputting the resident's message to the visitor and inputting the visitor's message to the resident, the resident may enter his messages via his laptop or the like in alphanumeric form, whereas the resident's message is outputted to the visitor as a voice message, and the visitor may input his message as a text message (according to the short message standard (SMS) or the like), whereas the visitor's message is outputted to the resident as a voice message. It is noted that, for example, a Bluetooth-enabled mobile phone may use a direct communication link to another Bluetooth-enabled mobile phone for transmitting voice data, in addition to its standard mobile phone communication link. Hereby, a voice-to-digital data conversion already takes place within the visitor's mobile phone, and only digital data are transmitted to the automatic door answering system.

In some embodiments, a doorbell button installed at the door initiates the authentication procedure performed by the automatic door answering system. Upon actuation of the doorbell button a request sent to the visitor's wireless communication system causes the retransfer of the authentication information. Hereby, the doorbell button may be equipped with electromechanical, capacitive, heat sensitive, humidity sensitive contacts, etc. Instead or in addition to the doorbell button, a proximity sensor may sense the physical presence of a visitor and may initiate the authentication procedure of the automatic door answering system. The proximity sensor may either be based on ultrasonic, infrared or visible light detection signals.

Various wireless communication standards allow for an automatic establishment of a communication link between two wireless communication systems when they are in close proximity. Thus, in some embodiments, the wireless communication interface of the automatic door answering system is implemented to cooperate with wireless communication systems enabling such a wireless communication standard in order to automatically initiate the authentication procedure when the visitor's wireless communication system is near to the wireless communication interface. For instance, the Bluetooth standard allows for an automatic allocation of the master/slave state to two Bluetooth-enabled communication devices coming within radio frequency range of each other. In particular, before any connection is established, every communication device is in a standby mode in which it periodically listens for messages from other communication systems. The connection procedure is initiated by any of the Bluetooth-enabled communication devices which then acts as the master while the other one(s) function(s) as slave(s). Once connected to each other, either one of the two communication devices may automatically start sending its identification information to the other device.

In some embodiments, the automatic door answering system comprises a door unlocking device arranged to unlock a door upon receipt of a specific authentication information from the visitor's wireless communication system. Such a door unlocking device may be provided for a house door, a garage door, mailbox door, garden door, etc. Additionally, a video camera may be installed at the door which records the visitor's presence upon his authentication and gives the visitor opportunity to leave his message via this video channel. Similarly, a video display may be provided at the door in order to play the resident's messages in video form to the visitor. The automatic door answering system may be connected to further intelligent house devices, such as automatic house-light-switching devices, automatic plant watering devices, house air conditioning devices, house heating devices and the like. Depending on the visitor's authentication and possibly further instructions sent via the visitor's messages to the automatic door answering system, a particular visitor might be given a specific range of control over these intelligent house devices. For example, during very hot summer periods a neighbor might be allowed to come to the resident's home during his absence in order to switch on the internal automatic plant watering device. During very cold winter seasons a neighbor might be similarly allowed to switch on the house internal heating devices in order to avoid damage due to freezing water.

In some embodiments, the authentication information is encrypted by a common encryption procedure (private key, etc.). For this, reference will be made to the various known encryption procedures. Most of the wireless communication standards provide for encrypting/decrypting authentication information.

Returning now to FIG. 1, an embodiment of the automatic door answering system will be described in more detail. FIG. 1 shows a resident's building 2, such as the resident's home, place of business or the like. The building 2 comprises a door 4 for receiving visitors. Adjacent to the door 4, a door bell button 6 is installed which enables the visitor to ring a building-internal doorbell (not shown). The doorbell button 6 is connected to a controller 8 of the automatic door answering system. As shown in FIG. 1, the automatic door answering system further comprises a wireless communication interface 10, a loudspeaker 12 and a microphone 14 which are all connected to the controller 8.

In a first step (A), a visitor carrying a mobile phone 16 which belongs to him rings the door bell by pressing the doorbell button 6 when arriving at the door 4. The controller 8 receives the signal created by the doorbell button 6 and causes the wireless communication interface 10 to send, in a second step (B), an authentication request via a direct communication link to the visitor's mobile phone 16. Upon receipt of the authentication request the visitor's mobile phone 16 transmits, in a third step (C), the requested authentication information to the wireless communication interface 10, and consequently to the controller 8. The controller 8 is internally coupled to a message storage 18 which stores a list of authorized persons in terms of their authentication information. For this, unique device IDs of the personal communication devices may be used. Hereby, the identification of the visitor automatically takes place without further manual interaction of the visitor. In an alternative embodiment, in response to the received authentication request, the visitor's mobile phone 16 enables the visitor to input his authentication (full name, nickname, password, etc.) and to send the same as authentication information (e.g. in the SMS format, etc.) to the wireless communication interface 10. In this case, the authentication information (full names, etc.) of all visitors for whom the resident wishes to leave one or more messages will be stored in the message storage 18 together with the corresponding individual resident's message. Furthermore, a resident message may be stored for visitors who cannot be identified.

For instance, the identified mailmen might be left the message to leave parcels and the like at a particular place at the resident's home, particular identified friends of the resident(s) might be given the information about the length of absence of the resident(s), other unidentified visitors might be merely generally informed about the absence of the resident for the moment.

In a fourth step (D), the controller 8 retrieves the corresponding resident's message from the message storage 18 in response to the received authentication information and outputs the same via the loudspeaker 12 as a voice message to the visitor at the door 4. Hereby, the loudspeaker 12 may be part of the building-internal intercom system used for communication between a visitor and the resident when at home.

Some resident's messages ask the visitor to leave a message for the resident if desired. If the visitor now chooses to leave such a visitor's message he speaks into the microphone 14 installed at the door 4 which is connected to the controller 8, in a fifth step (E). Again, the microphone 14 may be part of the building-internal intercom system. The controller 8 stores the recorded visitor's message into the internal message storage 18 in association with the visitor's authentication information as received beforehand. The resident is then able to listen to all recorded visitor's messages by stepping through the list of visitors authenticated at his door 4 during his absence, and to play back associated visitor's messages that have been recorded. In order to play back the visitor's messages, an input device 20 is connected to the controller 8 which gives the resident the following control possibilities over the automatic door answering system:

inputting resident's messages together with the related visitor's authentication information,

stepping through the list of all visitors identified (or authenticated) at his door 4 during his absence,

playing back recorded visitor's messages,

deleting recorded visitor's messages and resident's messages, and/or

allocating further authorization to particular visitors, for example the authorization to unlock the door 4 and the like.

If the resident has authorized a particular visitor to unlock the door 4, the automatic door answering system will ask the authenticated visitor via a corresponding message outputted by the loudspeaker 12 whether the visitor now wants to unlock the door 4. The visitor consents thereto by speaking a voice message into the microphone 14. The controller 8 internally comprises a voice recognition unit (not shown) that recognizes the consent of the visitor and causes an unlock device 22 to unlock the resident's door 4, in a sixth step (F).

In an alternative embodiment, a proximity sensor 24 is coupled to the controller 8 and installed at the door 4 which senses the proximity of a visitor. When a visitor comes close to the door 4, the proximity sensor 24 initiates the controller 8 to request authentication of the visitor. Hereby, the visitor no longer needs to press the doorbell button 6 in order to start the authentication procedure.

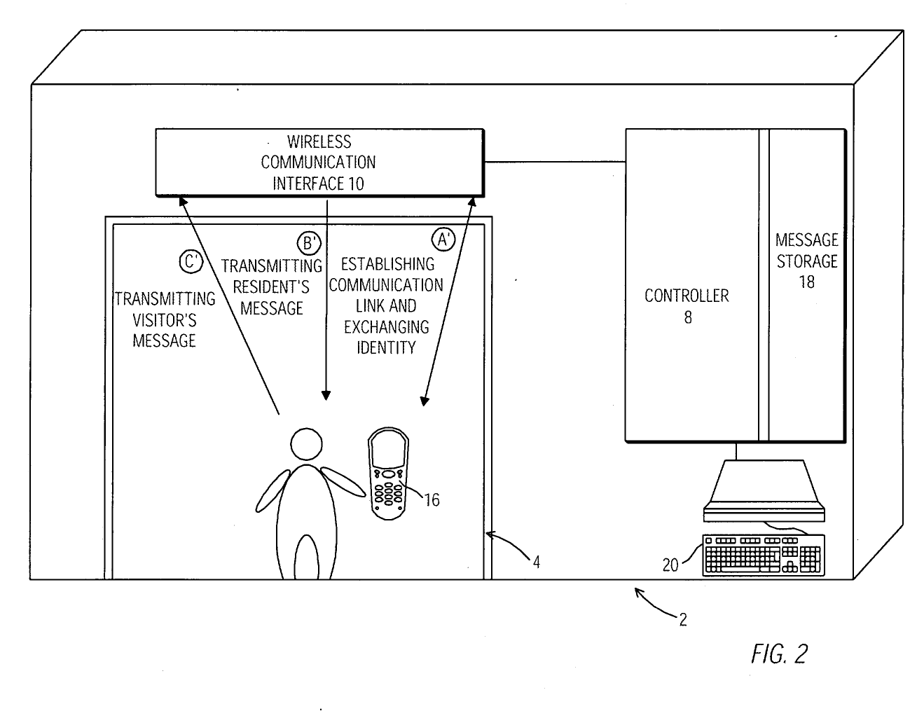

FIG. 2 shows another embodiment of an automatic door answering system. In this figure, the same parts which are already shown in FIG. 1 are designated with the same reference numbers. The embodiment of FIG. 2 differs from the one of FIG. 1 in that the direct communication link between the visitor's mobile phone 16 and the wireless communication interface 10 takes over the role of the doorbell button 6, the proximity sensor 24, the loudspeaker 12, and the microphone 14 of the embodiment shown in FIG. 1. Here, the direct communication link is capable to automatically sense the proximity of the visitor's mobile phone 16 to the wireless communication interface 10. As already stated above, the Bluetooth standard as well as other wireless communication standards allow for such an automatic come close enough to each other. As soon as a connection is made between a Bluetooth-enabled mobile phone 16, in a step (A′), an exchange of a unique Bluetooth identity (called global ID) takes place between the wireless communication interface 10 and the visitor's mobile phone 16. The controller 8 selects a stored resident's message in response to the received identity of the visitor's mobile phone 16 and transmits the same via the wireless communication interface 10 to the mobile phone 16, in a step (B′). The message may for example be sent in text and/or voice message form. The visitor is now able to leave his message for the resident, in a step (C′). He can do so by either entering an SMS (Short Message Standard) or a voice message into his mobile phone 16 and by transmitting the same to the wireless communication interface 10, and consequently to the automatic door answering system. In the embodiment of FIG. 2, every visitor approaching to the visitor's door 4 closely enough automatically initiates the authentication procedure by means of his mobile phone 16 and the subsequent retrieval of a resident's message without the need for any manual interaction. The first time a visitor needs to manually interact is when leaving his message for the resident.

In the above description of the embodiments shown in FIGS. 1 and 2 further detailed information about the specific implementation of the various parts of the automatic door answering system has been omitted since the skilled person immediately knows how to implement those parts. For instance, if the automatic door answering system is analogously implemented, a tape recorder (as message storage 18) will be used for recording visitor's and resident's messages. The controller 8 controls the playback, recording, fast forward/backward modus of this tape recorder in order to select a recorded resident's message in response to the identification of the visitor. In a digital implementation of the automatic door answering system, analog to digital converters are provided to convert voice signals for subsequent digital storage. In addition, a speech synthesizer may be used to convert text messages (resident's or visitor's messages) into voice messages. This allows the resident to input his messages in text form via his personal notebook or PAD and to store them in the same form within the message storage 18. Before outputting the thus-stored resident's messages via the loudspeaker 12, the speech synthesizer converts the text message into a voice message. The controller 8 of the automatic door answering system may be implemented in an ASIC (Application Specific Integrated Controller) on condition that it is equipped with an appropriate computer program, for example, on the basis of the C software language. The wireless communication interface 10 may be implemented as a single specific chip enabling the desired direct communication link.

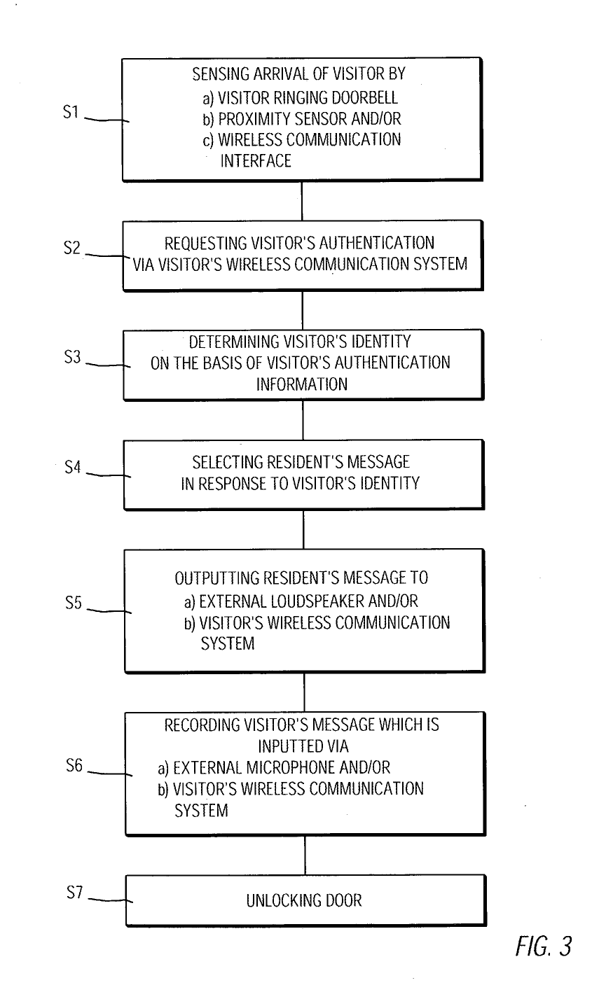

FIG. 3 shows a flow diagram illustrating the method steps included in an embodiment of the automatic door answering method. In a first step S1, the arrival of a visitor is sensed as a result of the visitor being required to ring the doorbell button 6, and/or the proximity sensor 24 sensing the proximity of the visitor, and/or the wireless communication interface 10 automatically establishing a direct communication link when the visitor's communication system is in close range to the wireless identification interface 10. In step S2, the visitor's communication system is requested for authentication via the established direct communication link. For this, the communication system 16 either automatically transmits identification information or the visitor enters his authentication information into his communication system and transmits it to the automatic door answering system. In step S3, the visitor's identity is checked on the basis of the received visitor's identification or authentication information. In step S4, a resident's message is selected in response to the checked visitor's identity. The selected resident's message is then outputted in step S5 to the visitor via the external loudspeaker 12 and/or the visitor's wireless communication system 16. Optionally, in step S6, the visitor is able to input a visitor's message into the automatic door answering system via the microphone 14 and/or his wireless communication system 16. Again optionally, in step S7, the visitor is enabled to unlock the door 4 by consenting to an associated request sent from the automatic door answering system.

The embodiments described enable resident's messages to visitors to be left automatically by using wireless communication systems carried by the visitors.

All publications and existing systems mentioned in this specification are herein incorporated by reference.

Although certain methods and systems constructed in accordance with the teachings of the invention have been described herein, the scope of coverage of this patent is not limited thereto. On the contrary, this patent covers all embodiments of the teachings of the invention falling within the scope of the appended claims, either literally or under the doctrine of equivalence.

1. An automatic door answering system for automatically leaving a resident's message for a visitor, comprising:
a wireless communication interface arranged to directly communicate with a visitor's wireless communication system and to receive authentication information from the visitor's wireless communication system; and
a message output component;
wherein the automatic door answering system is arranged to check the identity of the visitor based on the authentication information and, in response to the result of the identity check, to cause the message output component to output a resident's message.

2. The automatic door answering system of claim 1, which is arranged to send the resident's message to the visitor's wireless communication system.

3. The automatic door answering system of claim 1, which further comprises a doorbell button and is arranged to send a request to the visitor's wireless communication system upon actuation of the doorbell button, wherein said request causes the visitor's wireless communication system to send the authentication information to the wireless communication interface.

4. The automatic door answering system of claim 1, which further comprises a proximity sensor arranged to sense the physical presence of a visitor, wherein the door answering system is arranged to send a request to the visitor's wireless communication system upon detection of the physical presence of a visitor, wherein said request is arranged to cause the visitor's wireless communication system to send the authentication information to the wireless communication interface.

5. The automatic door answering system of claim 1, wherein a wireless communication link between the wireless communication interface and the visitor's communication system is arranged to be automatically established in response to the proximity of the visitor's communication system to the wireless communication interface.

6. The automatic door answering system of claim 1, which further comprises a door unlocking device arranged to unlock a door, wherein the door answering system is arranged to unlock the door upon receipt of specific authentication information from the visitor's wireless communication system.

7. The automatic door answering system of claim 1, wherein the message output component comprises a loudspeaker that is arranged to output a voice message as the resident's message to the visitor.

8. The automatic door answering system of claim 1, which further comprises a message storage arranged to store a resident's message.

9. The automatic door answering system of claim 8, which is further arranged to store a visitor's message into the message storage which is inputted by a visitor's input device.

10. The automatic door answering system of claim 8, which further comprises a resident's input device coupled to the message storage that enables the resident to input a resident's message into the message storage.

11. The automatic door answering system of claim 8, wherein the message storage is arranged to store a plurality of authentication information along with corresponding resident's messages, and the door answering system is arranged to select a resident's message in response to specific authentication information.

12. The door answering system of claim 1, wherein the wireless communication interface is selected from the group consisting of a Bluetooth interface, an infrared interface, and a wireless local area network interface.

13. The door answering system of claim 1, wherein the wireless communication interface is arranged to decrypt authentication information which is sent in encrypted form from the visitor's wireless communication system.

14. An automatic door answering system for automatically leaving a resident's message for a visitor, comprising:
a wireless communication interface arranged to directly communicate with a visitor's wireless communication system and to receive identification information from the visitor's wireless communication system, and
a message output component;
wherein the automatic door answering system is arranged to cause the message output component to output a resident's message in response to the identification information received.

15. A method of automatically answering a door by using an automatic door answering system and a visitor's wireless communication system, the method comprising the steps of:
establishing a direct wireless communication link between the visitor's wireless communication system and the automatic door answering system upon arrival of the visitor at the door;
transmitting authentication information from the visitor's wireless communication system to the door answering system via the established direct wireless communication link;
checking the identity of the visitor based on the authentication information transmitted; and
outputting a resident's message to the visitor in response to the result of the identity check.

16. The method of claim 15, wherein authentication information is decrypted by the automatic door answering system which is sent in encrypted form by the visitor's wireless communication system.

17. A method of automatically answering a door by using an automatic door answering system and a visitor's wireless communication system, the method comprising the steps of:
establishing a direct wireless communication link between the visitor's wireless communication system and the automatic door answering system upon arrival of the visitor at the door;
transmitting identification information from the visitor's wireless communication system to the door answering system via the established direct wireless communication link; and
outputting a resident's message to the visitor in response to the identification information transmitted.

18. A user wireless communication device arranged to communicate with an automatic door answering system which automatically leaves a resident's message for the user, wherein the communication between the user wireless communication device and the automatic door answering system comprises a direct communication between the user wireless communication device and a wireless communication interface included in the automatic door answering system for receiving authentication information from the user wireless communication device and for causing the automatic door answering system to check the identity of the user based on the authentication information received and, in response to the result of the identity check, to output a resident's message.

19. A user wireless communication device for use with an automatic door answering system for automatically leaving a resident's message for the user, the automatic door answering system comprising:
a wireless communication interface arranged to directly communicate with the user wireless communication device and to receive authentication information from the user wireless communication device; and
a message output component;
wherein the automatic door answering system is arranged to check the identity of the user based on the authentication information and, in response to the result of the identity check, to cause the message output component to output a resident's message.
